(19) United States
(12) Patent Application Publication
(10) Pub. No.: US 2019/0070718 A1
(43) Pub. Date: Mar. 7, 2019

(54) PNEUMATIC STAPLER

(71) Applicant: PATEK PNEUMATICS CO., LTD., New Taipei City (TW)

(72) Inventors: Hsien Cheng CHEN, New Taipei City (TW); Yao Hong WANG, New Taipei City (TW)

(73) Assignee: PATEK PNEUMATICS CO., LTD., New Taipei City (TW)

(21) Appl. No.: 16/044,471

(22) Filed: Jul. 24, 2018

(30) Foreign Application Priority Data
Sep. 7, 2017 (TW) 106130696

(51) Int. Cl. B25C 5/13; B25C 5/02

(52) U.S. Cl. CPC B25C 5/13; B25C 5/0285

(57) ABSTRACT

A pneumatic stapler has a main body internally loaded with straight staple-forming wires and including a staple-driving and a wire-bending control chamber. A staple-driving element carrier is movably mounted in the staple-driving control chamber and divides the latter into a first and a second staple-driving gas flowing space. When the staple-driving element carrier moves in the second staple-driving gas flowing space to push one staple out of the main body into a workpiece, the initially isolated first staple-driving control chamber is now communicable with the wire-bending control chamber, allowing part of the gas supplied to the pneumatic stapler to flow into the wire-bending control chamber and move a wire-bending element mounted therein to bend one staple-forming wire into a staple. Therefore, the pneumatic stapler requires only one pressure source to complete both staple-driving and wire-bending operations and can have more staple-forming wires loaded therein to provide high convenience in use.

### FIELD OF THE INVENTION

The present invention relates to a pneumatic stapler capable of bending straight staple-forming wires into U-shaped staplers while performing a staple-driving operation; and more particularly, to a pneumatic stapler that requires only one pressure source to perform both a staple-driving operation and a wire-bending operation.

### BACKGROUND OF THE INVENTION

In general woodworking, an interior decorator often uses nails to fixedly connect two or more pieces of wood workpieces to one another. However, there are usually many points between the wood workpieces that require fixed connection, and the interior decorator has to consume a lot of time and effort to manually drive the nails into the workpieces with a hammer at the risk of carelessly injuring his fingers by the hammer. To overcome the above disadvantage, a pneumatic stapler designed for woodworking has been introduced into the market. In the conventional pneumatic stapler, there is a magazine loaded with a plurality of staples. When the pneumatic stapler is connected to a pressure source, gas supplied from the pressure source drives one of the staples into the workpieces each time, so that a user can handle the woodworking in a safe, labor-saving and highly efficient manner.

However, the currently available pneumatic stapler can only use the gas from the pressure source to drive the staples into the workpieces. The staples are U-shaped and can be more easily pushed into the workpieces. To use the U-shaped staples, the magazine for loading them must be configured corresponding to the staples. In the case of a relatively short magazine, only a small number of staples can be loaded therein. On the other hand, a relatively long magazine might cause inconvenience in handling the woodworking. When the staples in the magazine of the conventional pneumatic stapler is about to be used up, the remaining staples tend to easily get stuck in a staple outlet of the magazine in the process of being driven into the workpieces.

Therefore, with the conventional pneumatic stapler, the number of staples that can be loaded at a time is restricted by the length of the magazine. With a relatively short magazine and accordingly less number of loadable staples, the user has to take time to change or replenish the magazine frequently, and is subjected to the problem of stuck staples when the staples in the magazine is running out. Once the staples are stuck in the staple outlet, the user has to stop using the pneumatic stapler for a while and gets it fixed. In some worse condition, money and time might be required to repair the pneumatic stapler.

### SUMMARY OF THE INVENTION

A primary object of the present invention is to provide a pneumatic stapler that requires only one pressure source to move a staple-driving element and a wire-bending element to a staple-driving position and a wire-bending position, respectively, for performing a staple-driving operation and a wire-bending operation sequentially or synchronously, and can have an increased number of straight staple-forming wire strips loaded therein at a time to provide high convenience in use.

Another object of the present invention is to provide the above pneumatic stapler that has a main body internally including a larger staple-driving control chamber and a smaller wire-bending control chamber, so that a larger part of the gas supplied from the only pressure source will flow into the staple-driving control chamber to produce a larger force to move the staple-driving element while a smaller part of the supplied gas will flow into the wire-bending control chamber to produce a smaller force to move the wire-bending element. With these arrangements, the wire-bending element won't be too quickly moved and thereby indirectly reduces the probability of forming damaged staples due to improper collision of the staple-forming wires with a bending block.

A further object of the present invention is to provide the above pneumatic stapler that includes a conveying assembly. When the wire-bending element is being moved away from a wire-bending position, the conveying assembly is actuated at the same to move one staple-forming wire forward each time to a position below the staple-driving element for performing a next staple-driving operation.

To achieve the above and other objects, the pneumatic stapler according to a first preferred embodiment of the present invention is capable of receiving an amount of gas supplied from a pressure source and includes a main body, a staple-driving mechanism and a wire-bending mechanism. The main body internally includes a staple-driving control chamber and a wire-bending control chamber, and has a plurality of straight staple-forming wires loaded therein. The wire-bending control chamber includes a first wire-bending gas flowing space located around an outer side of the staple-driving control chamber and a second wire-bending gas flowing space dimensionally smaller than the staple-driving control chamber. The first wire-bending gas flowing space is communicable with the staple-driving control chamber, and the second wire-bending gas flowing space is communicable with the first wire-bending gas flowing space via a third wire-bending gas flowing space. At least one first through hole and at least one second through hole diametrically smaller than the first through hole are provided between the first wire-bending gas flowing space and the staple-driving control chamber; and the first through hole is axially located at a distance below the second through hole, such that a spacing distance is formed between the first and the second through hole.

The staple-driving mechanism includes a staple-driving element carrier axially movable in the staple-driving control chamber and divides the latter into a first and a second staple-driving gas flowing space. The first staple-driving gas flowing space is initially not communicable with the wire-bending control chamber and accordingly in an isolated state for receiving the supplied gas. The staple-driving element carrier is able to move a staple-driving element to a staple-driving position, at where the staple-driving element pushes one of the staple-forming wires, which has already been bent into a staple, out of the main body into a workpiece. Further, the spacing distance is larger than a thickness of the staple-driving element carrier.

The wire-bending mechanism includes a movable member axially movable in the wire-bending control chamber, a wire-bending element, and a return spring disposed in the wire-bending control chamber. The staple-driving element carrier is movable by the supplied gas in the staple-driving control chamber to change a size of the first staple-driving gas flowing space relative to the second staple-driving gas flowing space, such that the first staple-driving gas flowing space is no longer in the isolated state but can communicate with the wire-bending control chamber, allowing the supplied gas received in the first staple-driving gas flowing space to flow into the wire-bending control chamber and move the movable member. The movable member moved by the supplied gas further brings the wire-bending element to a wire-bending position for bending one of the staple-forming wires into a staple. The return spring normally pushes the movable member upward, so that the movable member brings the wire-bending element to a ready-for-bending position, which is located away from the wire-bending position, and the wire-bending element in the ready-for-bending position is located away from the staple-forming wires. Wherein, the movable member is located in the second wire-bending gas flowing space. In a second preferred embodiment of the present invention, the wire-bending mechanism includes a return passage instead of the return spring. The return passage communicates with the wire-bending control chamber for guiding the supplied gas into the wire-bending control chamber. The supplied gas flowed into the wire-bending control chamber upward pushes against the movable member, so that the movable member brings the wire-bending element to a position away from the wire-bending position.

In the preferred embodiments, the second staple-driving gas flowing space is always communicable with the wire-bending control chamber, so that both of the first and the second staple-driving gas flowing space are communicable with the wire-bending control chamber in the process the wire-bending element is moving to the wire-bending position. Further, with the second through hole being provided on the staple-driving control chamber within a middle section thereof, the wire-bending element is also moved to the wire-bending position when the staple-driving element is moved to the staple-driving position. Alternatively, the second through hole can be provided on the staple-driving control chamber within a lower part or an upper part thereof, such that the staple-driving element and the wire-bending element are sequentially moved to the staple-driving position and the wire-bending position, respectively.

Further, the wire-bending mechanism also includes a transmission assembly connected to between the movable member and the wire-bending element, and the wire-bending element is moved away from the wire-bending position by the movable member via the transmission assembly. At this point, the transmission assembly also causes a conveying mechanism installed in the main body and pivotally connected to the transmission assembly to move the staple-forming wires forward, so that the first one of the staple-forming wires is located to one side of the staple-driving element.

In the preferred embodiments, the transmission assembly includes a first transmission element axially connected to the movable member and a second transmission element horizontally connected to the first transmission element, such that the first transmission element is located parallelly to the staple-driving element while the second transmission element is located perpendicularly to the staple-driving element. The second transmission element is connected at an end opposite to the first transmission element to the wire-bending element, so that the wire-bending element is located close to the staple-driving element with a distance between the staple-driving element and the wire-bending element being equal to at least a total width of two parallelly arranged staple-forming wires. The conveying mechanism includes a conveying assembly in contact with the staple-forming wires and a swing arm connected to between the conveying assembly and the transmission assembly. The swing arm brings the conveying assembly to move forward only one staple-forming wire each time and in only one direction.

A part of the swing arm forms a pivot end connected to the conveying assembly while the other part of the swing arm forms a movement rail. The transmission assembly includes an outward extended boss for extending into the movement rail, such that the swing arm swings about the pivot end when the boss moves reciprocatingly in along the movement rail. The conveying assembly includes a transmission belt in contact with the staple-forming wires and two spaced pulleys assembled to the transmission belt. One of the two pulleys is connected to the swing arm via a limiting unit, such that the two pulleys are limited by the limiting unit to rotate in only one direction.

From the above description, it can be found the present invention is characterized in that the gas supplied from the pressure source into the main body first downward pushes the staple-driving element carrier, so that the staple-driving element is moved to the staple-driving position and the first and the second staple-driving gas flowing space all become communicable with the wire-bending control chamber, allowing the supplied gas to flow into the second wire-bending gas flowing space of the wire-bending control chamber to move the wire-bending element to the wire-bending position. With these arrangements, the pneumatic stapler of the present invention requires only one pressure source to move both of the staple-driving element and the wire-bending element, so that the pneumatic stapler can perform two functions, namely, staple-driving and wire-bending, and more pieces of straight staple-forming wire strips can be loaded in the pneumatic stapler at a time to provide higher convenience in use.

In addition, since the second wire-bending gas flowing space of the wire-bending control chamber is dimensionally smaller than the staple-driving control chamber, most part of the supplied gas flows into the staple-driving control chamber to more quickly move the staple-driving element carrier while only a small part of the supplied gas flows into the second wire-bending gas flowing space to move the movable member at a slower speed. In other words, the pneumatic stapler of the present invention produces a relatively large staple-driving force but a relatively small wire-bending force. With these arrangements, the wire-bending element won't be too quickly moved and thereby indirectly reduces the probability of forming damaged staples due to improper collision of the staple-forming wires with a bending block.

Moreover, when the return spring pushes the movable member to the ready-for-bending position, the transmission assembly connected to the movable member also actuates the conveying assembly to move the uppermost staple-forming wire strip forward, so that the first one of the staple-forming wires is located to one side of the staple-driving element, allowing the staple-driving element to perform a next staple-driving operation at any time.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a pneumatic stapler according to a first preferred embodiment of the present invention;

FIG. 2 is a sectional view taken along line A-A of FIG. 1;

FIG. 3 is a fragmentary, sectional view of a cap included in the pneumatic stapler according to the first preferred embodiment of the present invention;

FIG. 4 is an enlarged sectional view of a one-way bearing included in the pneumatic stapler according to the first preferred embodiment of the present invention;

FIG. 5 is a cutaway view of a staple-forming wire storage mechanism included in the pneumatic stapler according to the first preferred embodiment of the present invention;

FIG. 6 is an exploded cutaway view of a staple-driving mechanism included in the pneumatic stapler according to the first preferred embodiment of the present invention;

FIG. 7A shows a staple-driving element of the staple-driving mechanism is located at a ready-for-driving position;

FIG. 7B shows the staple-driving element is located at a staple-driving position;

FIG. 8 is an exploded perspective view of a wire-bending mechanism included in the pneumatic stapler according to the first preferred embodiment of the present invention;

FIG. 9A shows a wire-bending element of the wire-bending mechanism is located at a ready-for-bending position;

FIG. 9B shows the wire-bending element is located at a wire-bending position;

FIG. 10A shows gas is supplied from a pressure source into a main body of the pneumatic stapler according to the first preferred embodiment of the present invention;

FIG. 10B shows the supplied gas flows from a first staple-driving gas flowing space into a first wire-bending gas flowing space in the pneumatic stapler according to the first preferred embodiment of the present invention;

FIG. 10C shows the completion of one staple-driving operation and one wire-bending operation by the pneumatic stapler according to the first preferred embodiment of the present invention;

FIG. 10D shows a bearing shaft of the one-way bearing of FIG. 4 rotates relative to a bearing case;

FIG. 10E shows a conveying mechanism included in the pneumatic stapler according to the first preferred embodiment of the present invention moves a staple-forming wire strip toward the wire-bending mechanism;

FIG. 10F shows the bearing case and the bearing shaft of the one-way bearing rotate synchronously;

FIG. 11 shows a pneumatic stapler according to a second preferred embodiment of the present invention;

FIG. 12A shows gas supplied to the pneumatic stapler according to the second preferred embodiment of the present invention flows into an intake chamber, an intake passage and a return passage thereof at the same time;

FIG. 12B shows the completion of one staple-driving operation and one wire-bending operation by the pneumatic stapler according to the second preferred embodiment of the present invention; and

FIG. 12C shows the wire-bending element is moved away from the wire-bending position in the pneumatic stapler according to the second preferred embodiment of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

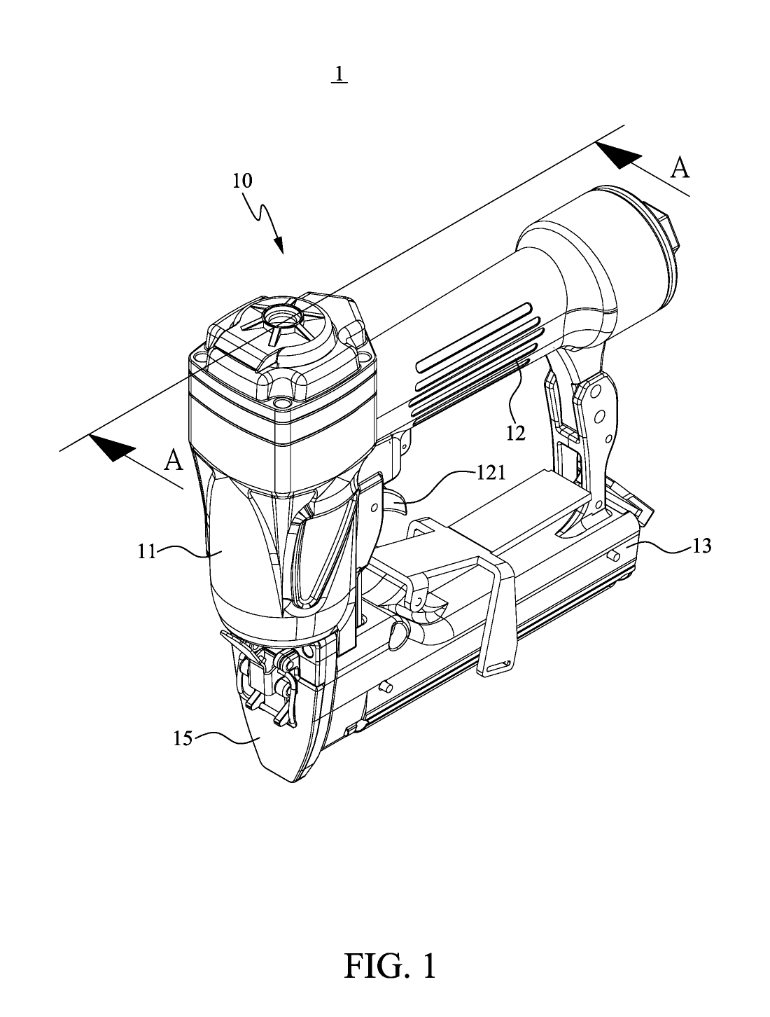

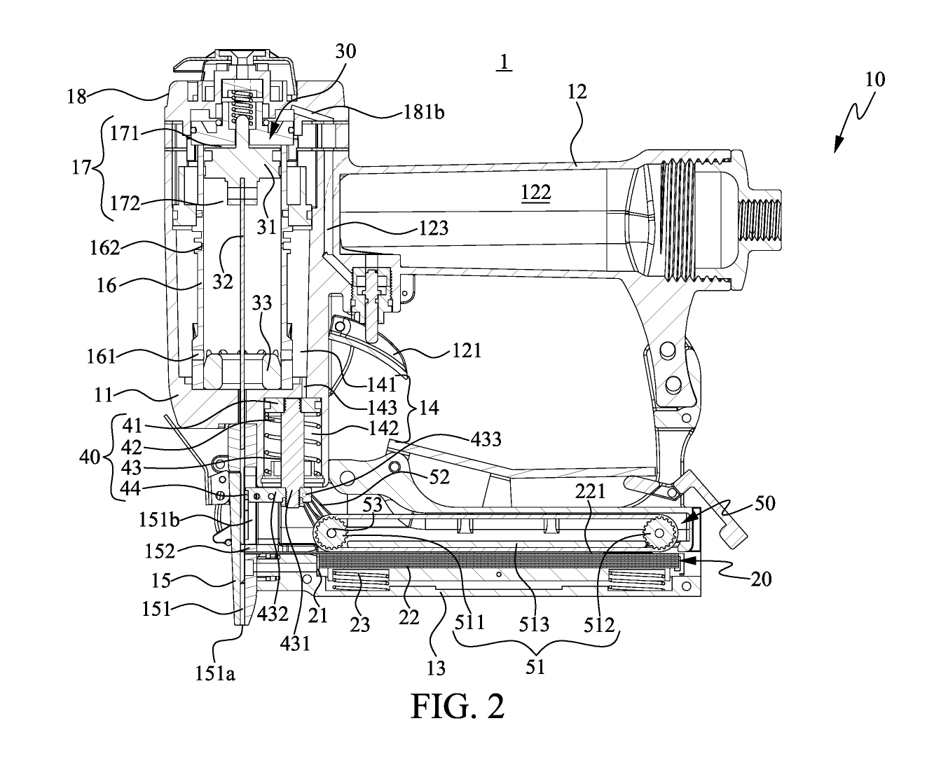

Please refer to FIGS. 1 and 2. A pneumatic stapler 1 according to a first preferred embodiment of the present invention mainly includes a main body 10, a staple-forming wire storage mechanism 20, a staple-driving mechanism 30, and a wire-bending mechanism 40. The main body 10 includes a staple-driving portion 11 located at a front side of the main body 10, a handle portion 12 sidewardly extended from an end of the staple-driving portion 11 and located at a rear side of the main body 10, and an assemblage portion 13 sidewardly extended from another end of the staple-driving portion 11 opposite to the handle portion 12 and also located at the rear side of the main body 10. The staple-driving portion 11 internally defines a wire-bending control chamber 14 and has a driving guide block 15 connected to a bottom thereof. In the wire-bending control chamber 14, there are a substantially column-shaped first wire-bending gas flowing space 141 and a substantially column-shaped second wire-bending gas flowing space 142. The driving guide block 15 internally defines an axially extended driving rail 151 and includes a sidewardly protruded bending block 152. An end of the driving rail 151 farther away from the wire-bending control chamber 14 forms a staple outlet 151a located at a lower side of the main body 10. A portion of the driving rail 151 located above the bending block 152 is sidewardly extended toward the rear side of the main body 10 to form a receiving space 151b.

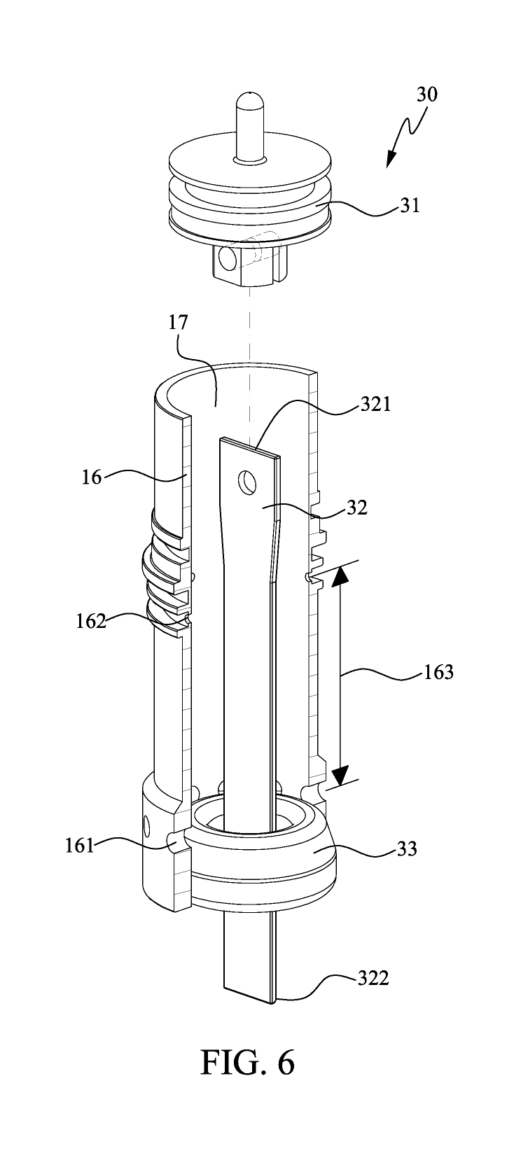

As can be seen in FIG. 2, the wire-bending control chamber 14 is internally provided with a cylindrical staple-driving control wall 16 and a staple-driving control chamber 17 defined in the cylindrical staple-driving control wall 16, such that the first wire-bending gas flowing space 141 in the wire-bending chamber 14 is located around an outer side of the staple-driving control chamber 17. The cylindrical staple-driving control wall 16 is provided around an end closer to the driving guide block 15 with a plurality of first through holes 161, and further provided around a location above the first through holes 161 with a plurality of second through holes 162, which respectively have a hole size smaller than that of the first through holes 161, such that the staple-driving control chamber 17 is communicable with the first wire-bending gas flowing space 141 via the first through holes 161 and the second through holes 162. According to the first preferred embodiment of the present invention, the second through holes 162 are located within a middle section of the cylindrical staple-driving control wall 16 and the first through holes 161 are located at a height lower than that of the second through holes 162, such that an spacing distance 163 (see FIG. 6) is formed between the locations of the first and of the second through holes 161, 162 on the cylindrical staple-driving control wall 16.

The second wire-bending gas flowing space 142 is dimensionally smaller than the staple-driving control chamber 17, and is communicable with the first wire-bending gas flowing space 141 via a third wire-bending gas flowing space 143, which is dimensionally smaller than the second wire-bending gas flowing space 142. The handle portion 12 of the main body 10 is provided with a trigger 121, and internally defines an intake chamber 122 communicable with the staple-driving control chamber 17 and an intake passage 123 communicable with the intake chamber 122. The intake passage 123 is connected at an end opposite to the intake chamber 122 to a cap 18, which is assembled to the staple-driving portion 11.

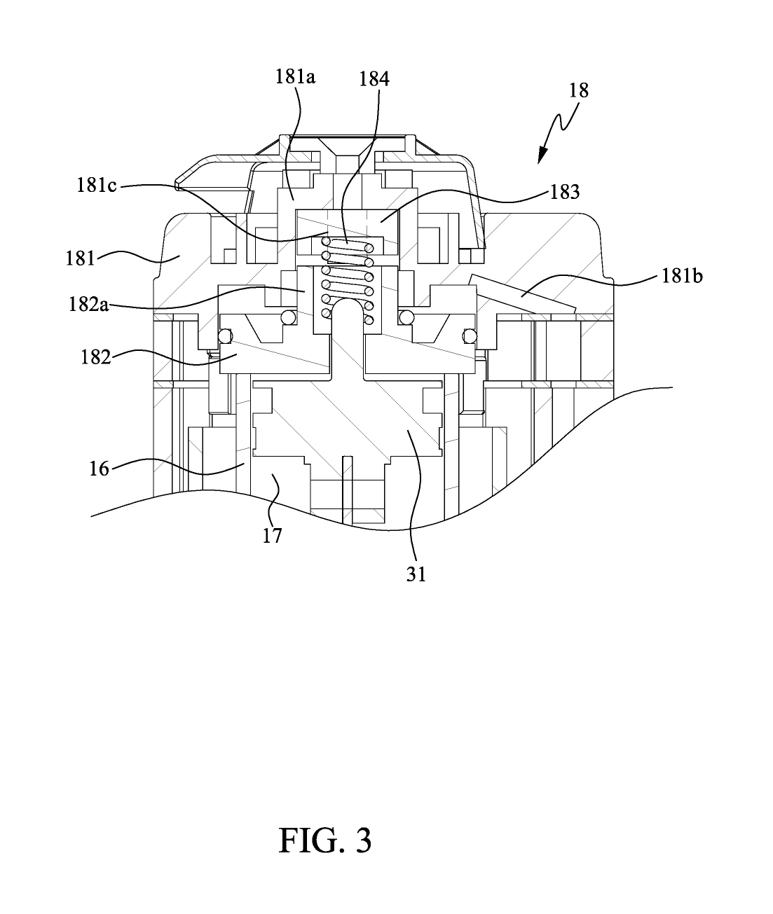

Please refer to FIG. 3. The cap 18 includes a fixing member 181, which is fixed to the staple-driving portion 11, and a shielding member 182, which is located between the fixing member 181 and the cylindrical staple-driving control wall 16. The fixing member 181 has a central portion that is extended to form a downward projected hollow fixing column 181a and a connecting passage 181b communicable with the intake passage 123. The fixing column 181a is internally provided with a pressing member 183, and is provided with a plurality of openings 181c for communicating with an environment outside the pneumatic stapler 1. The shielding member 182 is reciprocally movable between the fixing member 181 and the cylindrical staple-driving control wall 16 and has a hollow shielding column 182a extended toward the fixing column 181a, such that the shielding column 182a is selectively in contact with the pressing member 183. An elastic member 184 is disposed in the shielding column 182a with two opposite ends of the elastic member 184 pressed against the shielding member 182 and the pressing member 183. The elastic member 184 normally pushes the shielding member 182 against an upper end of the cylindrical staple-driving control wall 16, so that the shielding column 182a is not in contact with the pressing member 183 and does not shield the openings 181c on the fixing column 181a.

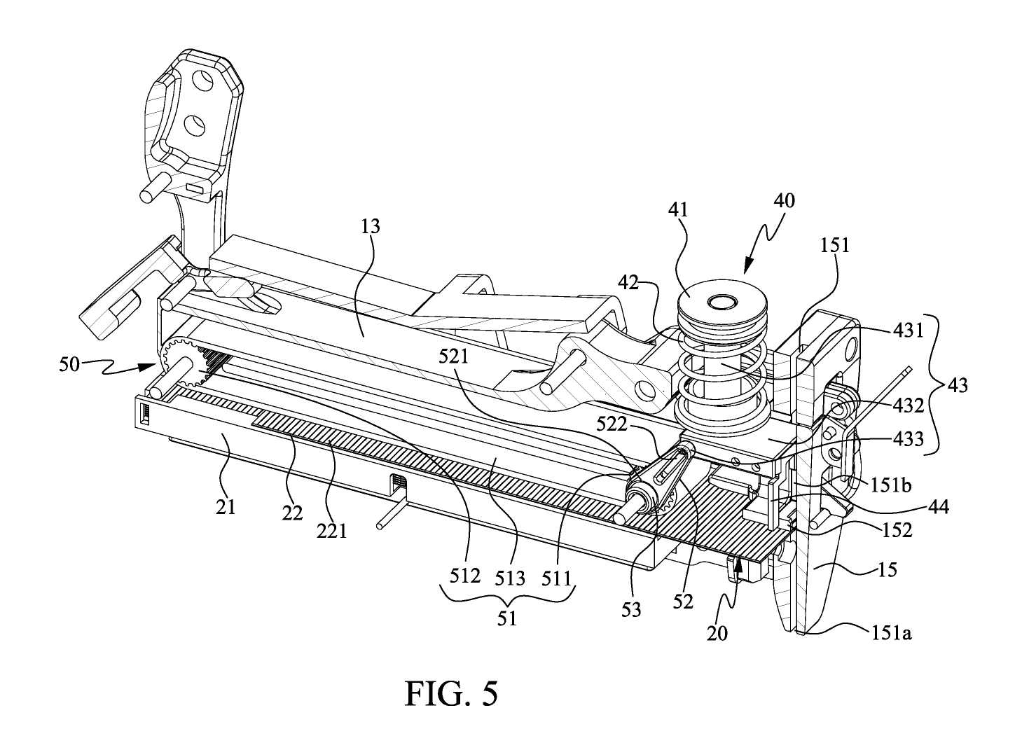

Please refer to FIGS. 1 and 2 again. The assemblage portion 13 of the main body 10 has a conveying mechanism 50 assembled therein. As shown, the conveying mechanism 50 includes a conveying assembly 51 and a swing arm 52. The conveying assembly 51 includes a first pulley 511 and a second pulley 512, which are spaced from each other but indirectly connected to each other via a transmission belt 513, such that the second pulley 512 is brought by the transmission belt 513 to rotate clockwise when the first pulley 511 rotates clockwise. As shown, a limiting unit 53 is assembled to one side of the first pulley 511 for limiting the first pulley 511 and the second pulley 512 to one-way rotation, i.e., to rotate in only one direction. A part of the swing arm 52 forms a pivot end 521 (see FIG. 5), to which the limiting unit 53 is connected, and the other part of the swing arm 52 forms a movement rail 522 (see FIG. 5).

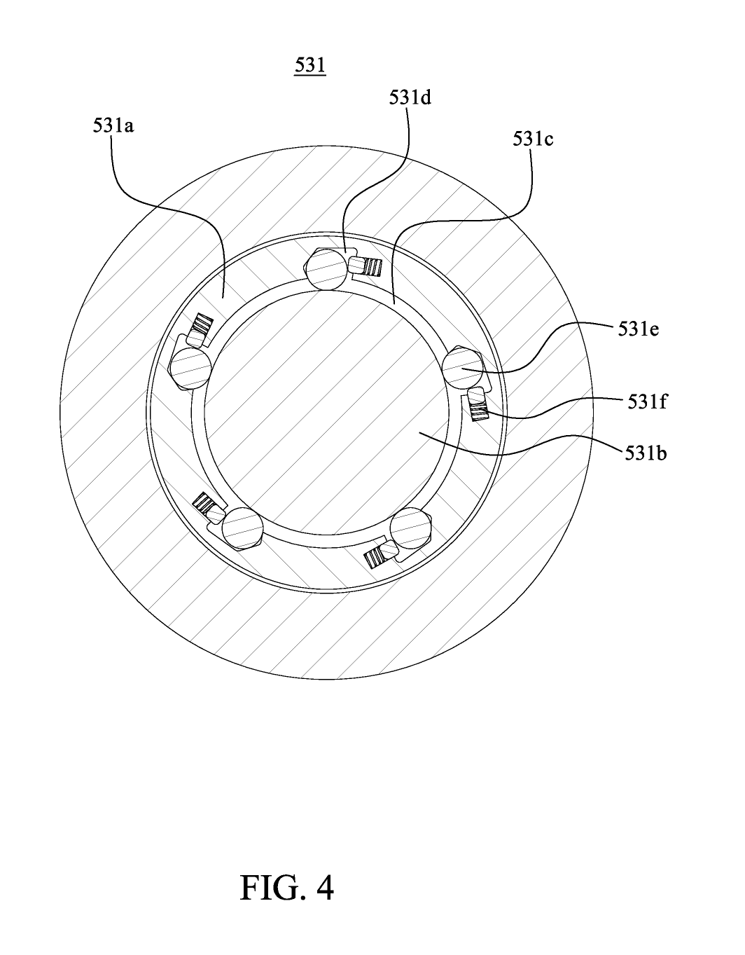

Please refer to FIG. 4. The limiting unit 53 is a one-way bearing 531 having a bearing case 531a and a bearing shaft 531b. The bearing case 531a is connected to the first pulley 511 and internally defines an assembling space 531c and a plurality of movement-allowance spaces 531d communicable with the assembling space 531c. The bearing shaft 531b is axially extended through the assembling space 531c. Each of the movement-allowance spaces 531d has a roller 531e and a push spring 531f received therein with the push spring 531f normally pushing against the roller 531e. The bearing shaft 531b is connected to the pivot end 521 of the swing arm 52. It is understood the above description of the limiting unit 53 as a one-way bearing 531 is only illustrative. In other operable embodiments, the limiting unit 53 can be otherwise a ratchet, for example.

Please refer to FIGS. 2 and 5. The staple-forming wire storage mechanism 20 includes a staple-forming wire magazine 21 located in the assemblage portion 13. A plurality of sequentially superposed staple-forming wire strips 22 is received in the staple-forming wire magazine 21 and located below the conveying assembly 51. Each of the staple-forming wire strips 22 includes a plurality of continuously and parallelly arranged straight staple-forming wires 221. A plurality of spaced elastic coils 23 is disposed between the lowest one of the superposed staple-forming wire strips 22 and the staple-forming wire magazine 21 to elastically upwardly push the plurality of staple-forming wire strips 22 toward the conveying mechanism 50, so that the uppermost one of the superposed staple-forming wire strips 22 is always in contact with the transmission belt 513 of the conveying assembly 51.

Please refer to FIGS. 2 and 6. The staple-driving mechanism 30 includes a staple-driving element carrier 31, a staple-driving element 32, and a buffering member 33. The staple-driving element carrier 31 has a thickness smaller than the spacing distance 163 and is located in the staple-driving control chamber 17 to divide the latter into a first staple-driving gas flowing space 171, which is closer to the cap 18, and a second staple-driving gas flowing space 172, which is closer to the driving guide block 15. The first and the second staple-driving gas flowing space 171, 172 can be communicable or not communicable with each other. The staple-driving element 32 has an upper end forming a connecting end 321 assembled to the staple-driving element carrier 31, and a lower end forming a pushing end 322 extended through the staple-driving control chamber 17 into the driving rail 151 behind the staple outlet 151a. The buffering member 33 is located in the staple-driving control chamber 17 and is made of a resilient material according to the first preferred embodiment of the present invention.

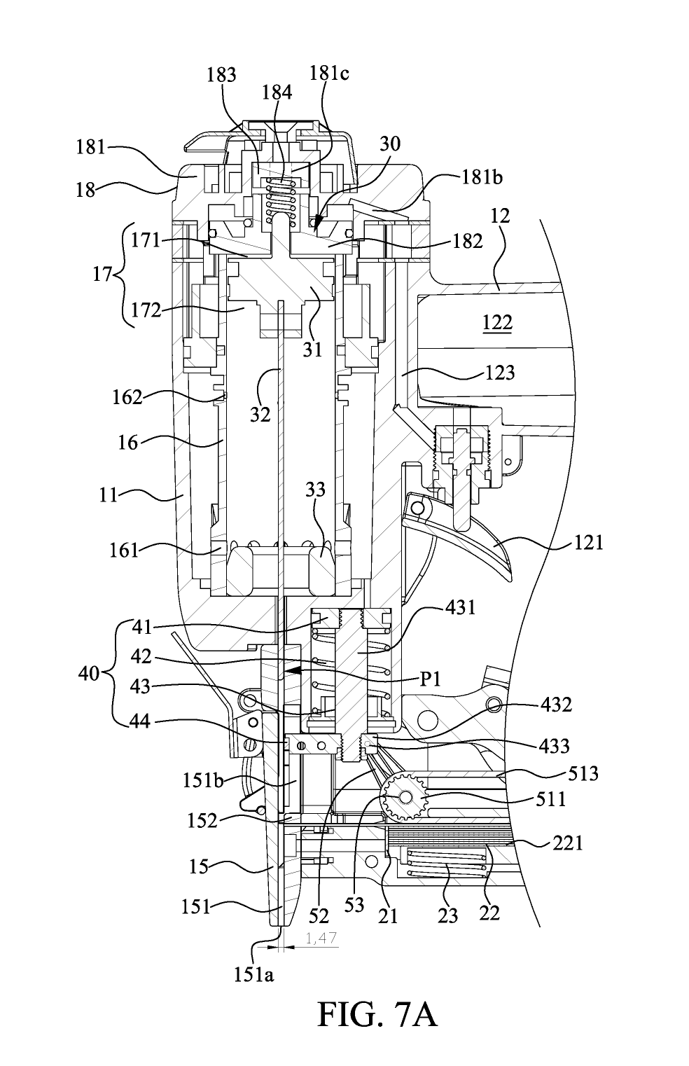

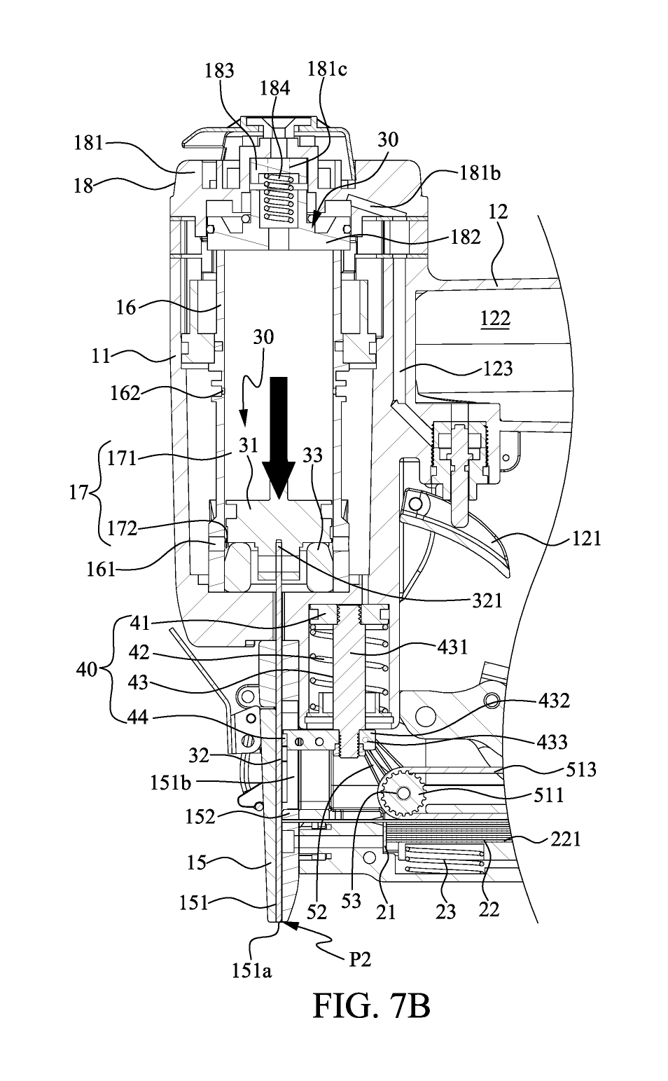

Please refer to FIGS. 6, 7A and 7B. The staple-driving element carrier 31 of the staple-driving mechanism 30 is movable in the staple-driving control chamber 17 of the main body 10, so that the moving staple-driving element carrier 31 changes the size of the first staple-driving gas flowing space 171 relative to the second staple-driving gas flowing space 172 in the staple-driving control chamber 17. Meanwhile, the moving staple-driving element carrier 31 brings the staple-driving element 32 from a ready-for-driving position P1, which is farther away from the staple outlet 151a, to a staple-driving position P2, in which the pushing end 322 of the staple-driving element 32 is extended beyond the staple outlet 151a.

Please refer to FIG. 7A. When the staple-driving element 32 of the staple-driving mechanism 30 is located at the ready-for-driving position P1, the staple-driving element carrier 31 is located at a height higher than the second through holes 162, and the first staple-driving gas flowing space 171 is smaller than the second staple-driving gas flowing space 172. Therefore, the first staple-driving gas flowing space 171 in the staple-driving control chamber 17 is not communicable with the first wire-bending gas flowing space 141 in the wire-bending control chamber 14 via the second through holes 162. However, the second staple-driving gas flowing space 172 is communicable with the first wire-bending gas flow space 141 via the first and the second through holes 161, 162.

Please refer to FIG. 7B. When the staple-driving element 32 of the staple-driving mechanism 30 is located at the staple-driving position P2, the staple-driving element carrier 31 is located at a height lower than the second through holes 162, and the first staple-driving gas flowing space 171 is larger than or equal to the second staple-driving gas flowing space 172. Therefore, the first staple-driving gas flowing space 171 is communicable with the first wire-bending gas flowing space 141 in the wire-bending control chamber 14 via the second through holes 162.

However, the second staple-driving gas flowing space 172 is communicable with the first wire-bending gas flow space 141 only via the first through holes 161. According to the first preferred embodiment, when the staple-driving element 32 is located at the staple-driving position P2, the staple-driving element carrier 31 is in contact with the buffering member 33.

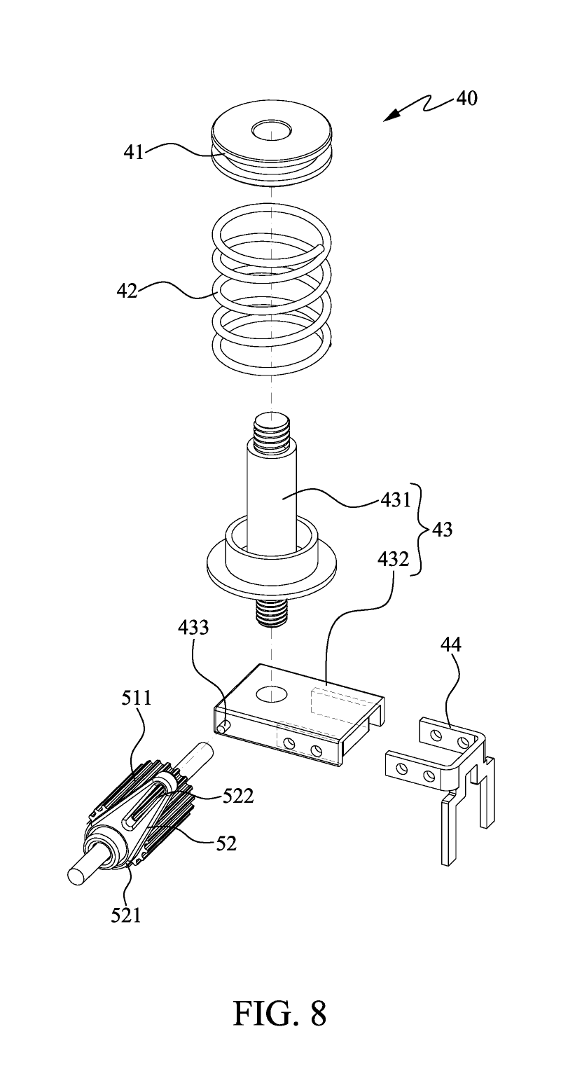

Please refer to FIGS. 2 and 8. The wire-bending mechanism 40 includes a movable member 41, a return spring 42, a transmission assembly 43, and a wire-bending element 44. The movable member 41 and the return spring 42 are in contact with each other and located in the second wire-bending gas flowing space 142 of the wire-bending control chamber 14. The movable member 41 is connected to the wire-bending element 44 via the transmission assembly 43. As shown, the transmission assembly 43 includes an upright first transmission element 431 located parallel to the staple-driving element 32, and a horizontally extended second transmission element 432 selectively contactable with the staple-driving element 32. The first and the second transmission element 431, 432 are assembled together, such that they are located substantially perpendicular to each other. The first transmission element 431 is axially extended through the return spring 42 to connect at an end farther away from the second transmission element 432 to the movable member 41. The horizontal second transmission element 432 is provided at an end closer to the upright first transmission element 431 with an outward extended boss 433 for extending into the movement rail 522 on the swing arm 52. The other end of the second transmission element 432 farther away from the first transmission element 431 is assembled to the wire-bending element 44, so that the wire-bending element 44 is located in the receiving space 151b, which is formed on the driving guide block 15 and communicable with the driving rail 151, and is located just above the bending block 152. With these arrangements, the wire-bending element 44 can be moved by the transmission assembly 43 toward the staple-driving element 32 with a distance between the staple-driving element 32 and the wire-bending element 44 being equal to a total width of two parallelly arranged staple-forming wires 221. However, it is understood the above description of the distance between the staple-driving element 32 and the wire-bending element 44 is only illustrative. In other operable embodiments of the present invention, the distance between the staple-driving element 32 and the wire-bending element 44 can be equal to a total width of three, four or five parallelly arranged staple-forming wires 221.

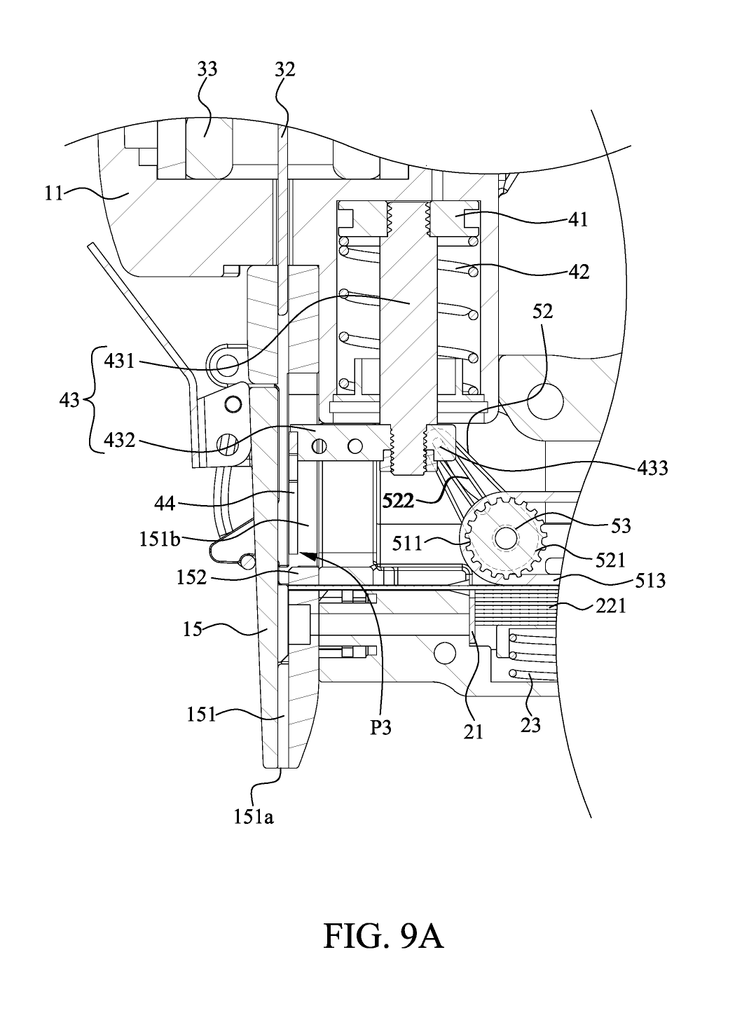

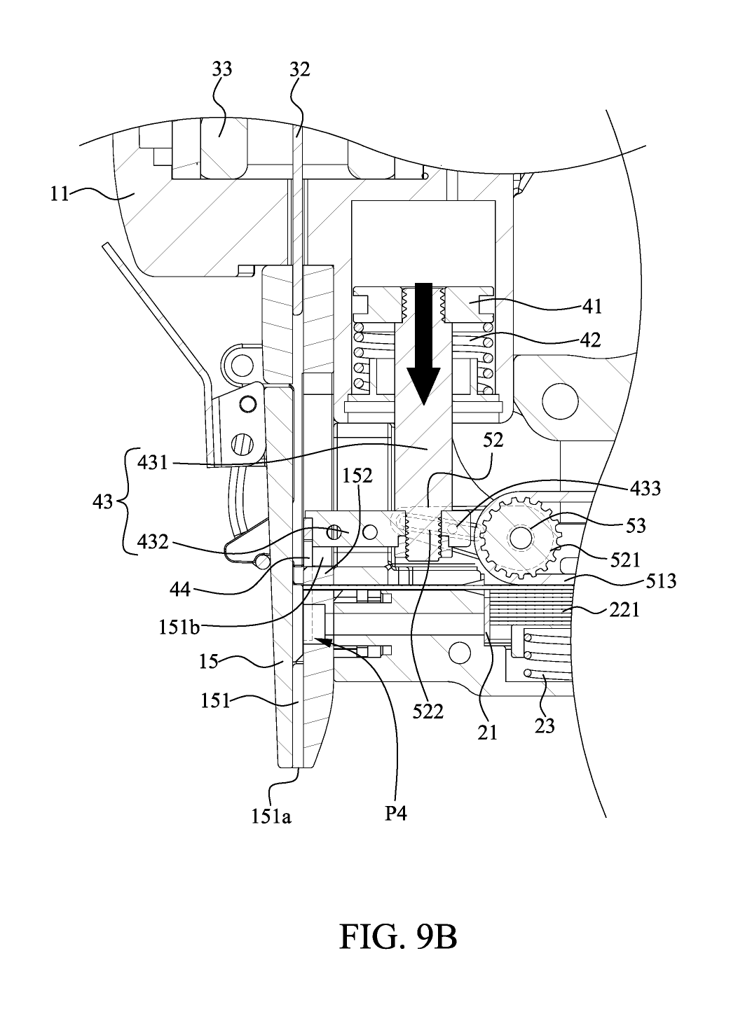

Please refer to FIG. 9A. The return spring 42 normally pushes against the movable member 41, so that the movable member 41 is located at the highest position in the second wire-bending gas flowing space 142. Meanwhile, the wire-bending element 44 is located at a ready-for-bending position P3 with a distance away from the bending block 152. Please refer to FIG. 9B. The movable member 41 is movable in the second wire-bending gas flowing space 142 of the wire-bending control chamber 14. When the movable member 41 is moved downward, it compresses the return spring 42, so that a relative distance between two opposite ends of the return spring 42 is shortened. When the movable member 41 is moving, the wire-bending element 44 is moved by the movable member 41 via the transmission assembly 43 from the ready-for-bending position P3 downward to a wire-bending position P4 close to the bending block 152. While the wire-bending element 44 is moving from the ready-for-bending position P3 to the wire-bending position P4, the boss 433 on the second transmission element 432 is also moving in along the movement rail 522, bringing the swing arm 52 to swing about the pivot end 521.

Please refer to FIGS. 2, 3 and 10A. In practical application of the pneumatic stapler 1 according to the first preferred embodiment of the present invention, the handle portion 12 of the main body 10 is connected to a pressure source (not shown), which supplies an amount of gas into the intake chamber 122 and the intake passage 123 in the handle portion 12. When the trigger 121 of the handle portion 12 is pulled, the supplied gas can flow only into the intake chamber 122 but not the intake passage 123. When the supplied gas flows into the intake chamber 122, it pushes the shielding member 182 of the cap 18 toward the fixing member 181, so that a gap is formed between the shielding member 182 and the cylindrical staple-driving control wall 16, allowing the supplied gas to flow from the intake chamber 122 into the first staple-driving gas flowing space 171 in the staple-driving control chamber 17. When the supplied gas flows into the first staple-driving gas flowing space 171, it downward pushes against the staple-driving element carrier 31, so that the latter is ready for moving the staple-driving element 32 from the ready-for-driving position P1 toward the staple-driving position P2. At this point, the staple-driving element carrier 31 is located at a position higher than the second through holes 162, and the first staple-driving gas flowing space 171 is isolated from and not communicable with the wire-bending control chamber 14, and not any of the supplied gas can flow into the wire-bending control chamber 14. Therefore, the movable member 41 of the wire-bending mechanism 40 does not move in the second wire-bending gas flowing space 142 of the wire-bending control chamber 14 and the wire-bending element 44 of the wire-bending mechanism 40 is located at the ready-for-bending position P3. When the shielding member 182 is moving toward the fixing member 181, the shielding column 182a of the shielding member 182 is finally in contact with the pressing member 183 to thereby shield the openings 181c, and the supplied gas can flow only into the staple-driving control chamber 17.

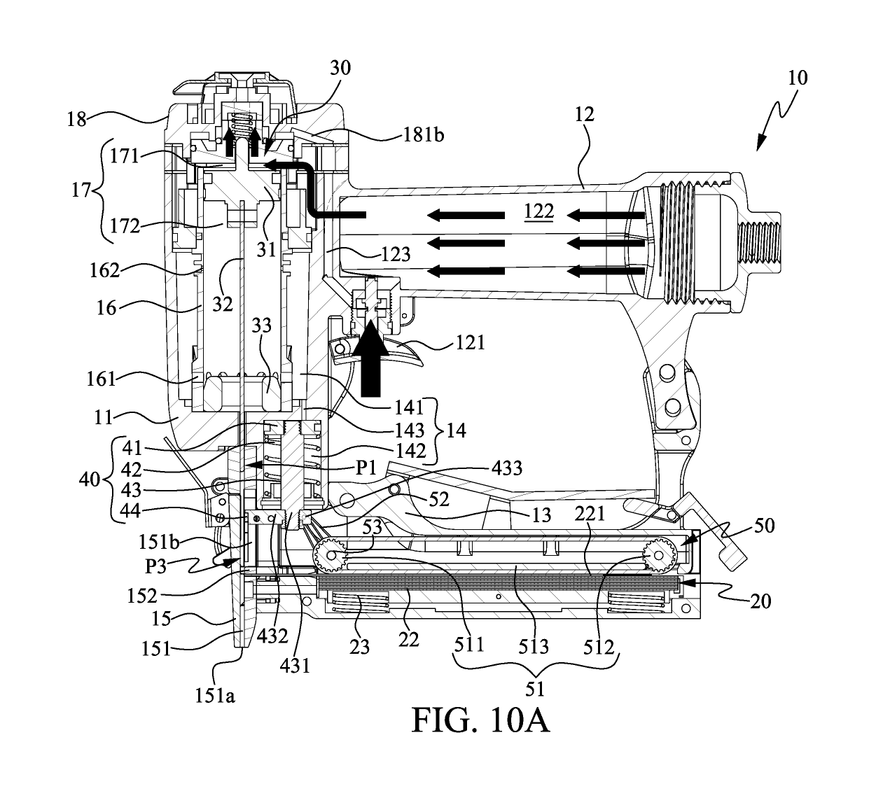

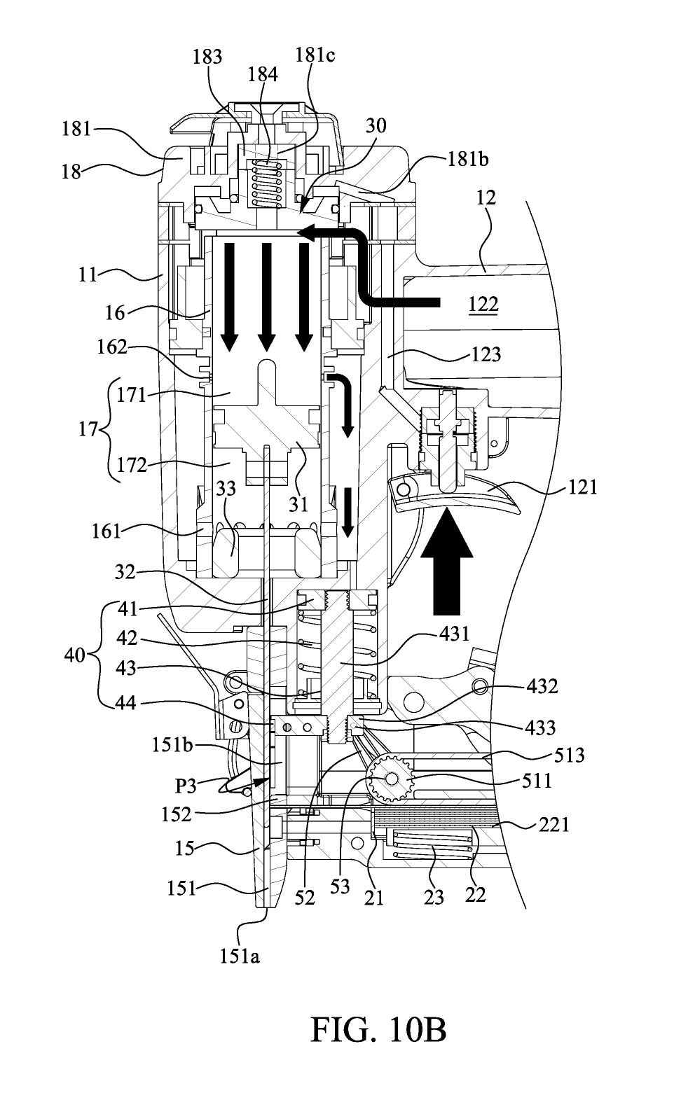

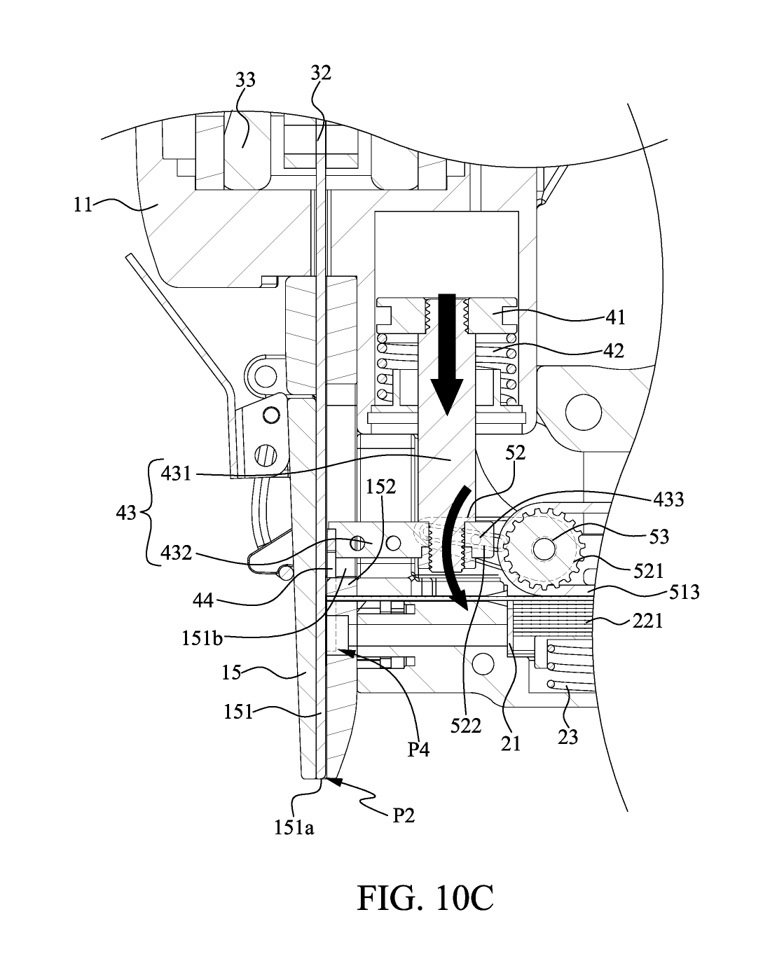

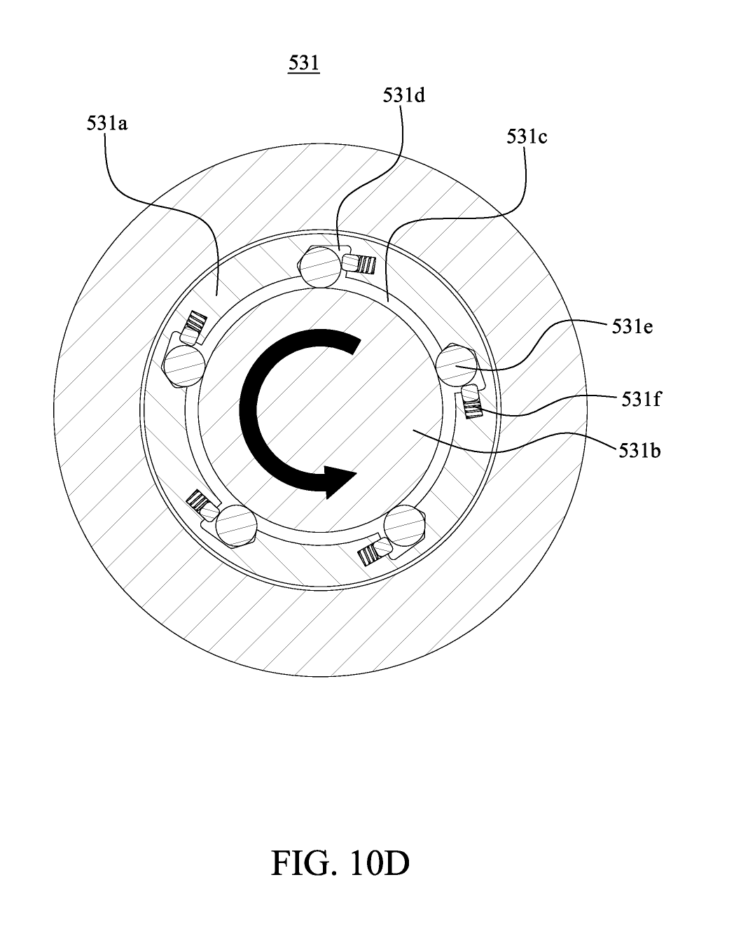

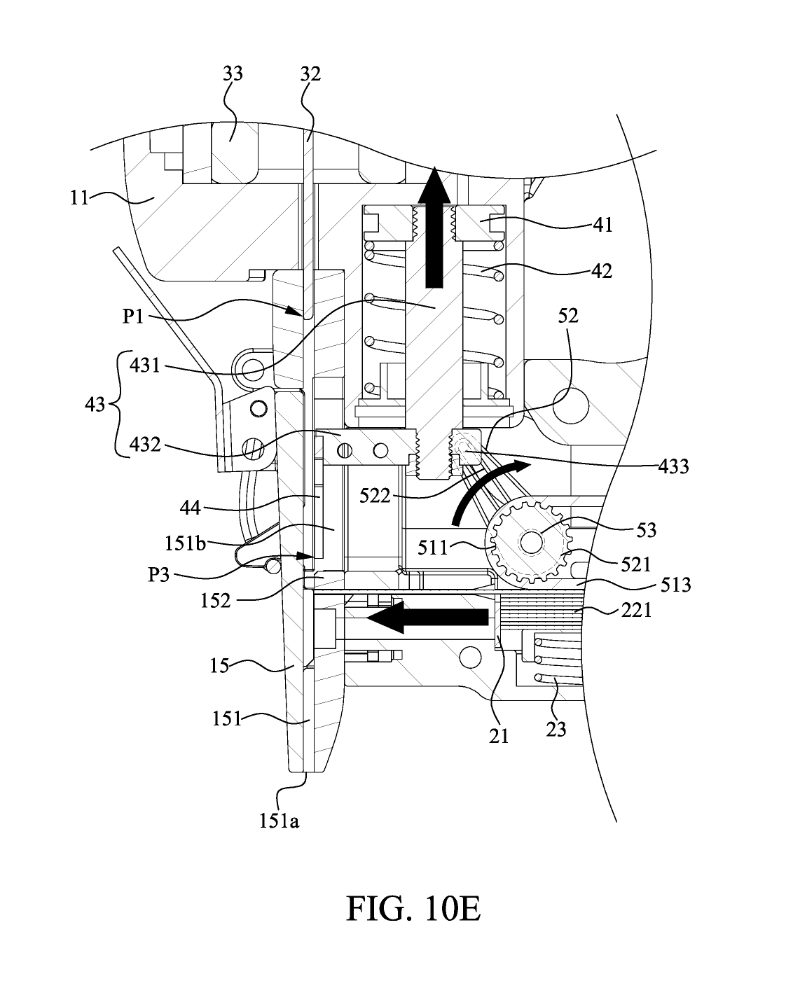

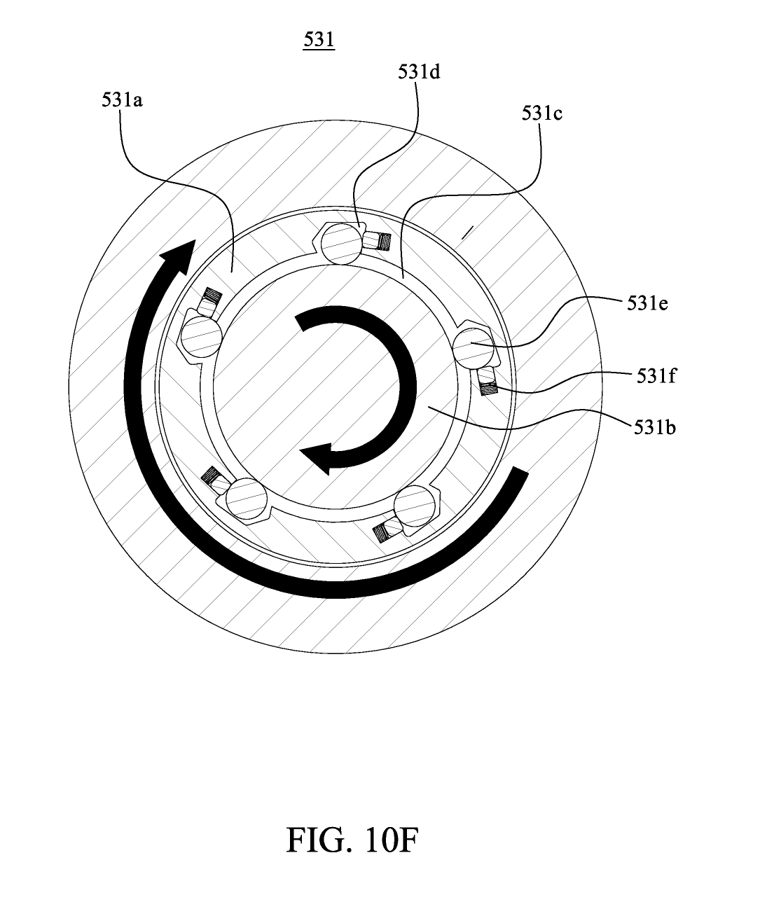

Please refer to FIGS. 2 and 10B. The staple-driving element carrier 31 of the staple-driving mechanism 30 pushed by the supplied gas moves downward in the staple-driving control chamber 17. When the staple-driving element carrier 31 is moved to a position between the first through holes 161 and the second through holes 162, it is located lower than the second through holes 162, and the first staple-driving gas flowing space 171 is no longer isolated from the wire-bending control chamber 14 but is communicable with the latter via the second through holes 162. Therefore, the first staple-driving gas flowing space 171 and the second staple-driving gas flowing space 172 are communicable with the first wire-bending gas flowing space 141 of the wire-bending control chamber 14 via the second through holes 162 and the first through holes 161, respectively. At this point, a part of the supplied gas forms staple-driving gas that pushes against the staple-driving element carrier 31, and another part of the supplied gas forms wire-bending gas that pushes against the movable member 41. The wire-bending gas flows from the first staple-driving gas flowing space 171 through the second through holes 162 into the first wire-bending gas flowing space 141, and then further flows through the third wire-bending gas flowing space 143 into the second wire-bending gas flowing space 142 to push against the movable member 41. Therefore, the movable member 41 is ready for moving the wire-bending element 44 via the transmission assembly 43 from the ready-for-bending position P3 to the wire-bending position P4. Since the second wire-bending gas flowing space 142 is dimensionally smaller than the staple-driving control chamber 17, the wire-bending gas has a volume smaller than that of the staple-driving gas. In other words, compared to the staple-driving gas, less gas volume is required to move the movable member 41 of the wire-bending mechanism 40.

Please refer to FIG. 10C. The staple-driving gas having a volume larger than the wire-bending gas also produces a relatively large force to push against the staple-driving element carrier 31, so that the staple-driving element carrier 31 carries the staple-driving element 32 to quickly move in along the driving rail 151 in the driving guide block 15 to the staple-driving position P2. When the staple-driving element 32 is located at the staple-driving position P2, the pushing end 322 of the staple-driving element 32 is pressed against a staple formed of one of the staple-forming wires 221 and moves the staple toward the staple outlet 151a, from where the staple leaves the main body 10 and is driven into a workpiece (not shown). Meanwhile, the staple-driving element carrier 31 is in contact with and buffered by the buffering member 33 to slow down.

With the second through holes 162 being provided within the middle section of the cylindrical staple-driving control wall 16, the movable member 41 of the wire-bending mechanism 40 will be still moving in the second wire-bending gas flowing space 142 when the staple-driving element 32 is located at the staple-driving position P2. In other words, the wire-bending element 44 is not located at the wire-bending position P4 when the staple-driving element 32 has been located at the staple-driving position P2. More specifically, when the movable member 41 moves the wire-bending element 44 via the transmission assembly 43 to the wire-bending position P4, the wire-bending gas, which has a volume smaller than the staple-driving gas, enables the wire-bending element 44 and the bending block 152 to together bend, with a relatively small force, the most front staple-forming wire 221 in the uppermost staple-forming wire strip 22 to form a staple. Further, in the process the wire-bending element 44 is moving from the ready-for-bending position P3 to the wire-bending position P4, the transmission assembly 43 also brings the swing arm 52 to swing about the pivot end 521 thereof, causing the boss 433 in the movement rail 522 to move from an end of the movement rail 522 farther away from the pivot end 521 to the other end closer to the pivot end 521. With the limiting unit 53 provided between the swing arm 52 and the first pulley 511, the first pulley 511 would not rotate when the swing arm 52 rotates counterclockwise.

However, it is understood the above description that the wire-bending element 44 is not located at the wire-bending position P4 when the staple-driving element 32 has reached the staple-driving position P2 is only illustrative. In other operable embodiments, the second through holes 162 can be provided within a lower or an upper part of the cylindrical staple-driving control wall 16, so that the second through holes 162 are located closer to the driving guide block 15 or the cap 18, respectively. With these arrangements, it is possible for the wire-bending element 44 to reach the wire-bending position P4 when the staple-driving element 32 has not yet arrived at the staple-driving position P2, or for the wire-bending element 44 and the staple-driving element 32 to reach the wire-bending position P4 and the staple-driving position P2, respectively, at the same time.

Please refer to FIG. 10D. When the swing arm 52 swings counterclockwise, the bearing shaft 531b of the one-way bearing 531 rotates synchronously. At this point, the push springs 531f push the rollers 531e against wall surfaces of the movement-allowance spaces 531d, preventing the bearing shaft 531b from bringing the bearing case 531a to rotate. Therefore, the first pulley 511 could not rotate when the swing arm 52 swings.

Please refer to FIGS. 2, 3 and 10E. When the trigger 121 of the handle portion 12 is released, the supplied gas flows into both of the intake chamber 122 and the intake passage 123. At this point, the shielding member 182 closes the upper end of the cylindrical staple-driving control wall 16 and stops the supplied gas from flowing into the staple-driving control chamber 17. Meanwhile, the openings 181c are not shielded by the shielding column 182a. Therefore, the staple-driving gas in the staple-driving control chamber 17 and the wire-bending gas in the wire-bending control chamber 14 can only flow through the openings 181c on the fixing member 181 into the environment outside the main body 10. At this point, the wire-bending gas flows through the first through holes 161 into the second staple-driving gas flowing space 172 of the staple-driving control chamber 17 to move the staple-driving element carrier 31 of the staple-driving mechanism 30 from a bottom to a top of the staple-driving control chamber 17. As a result, the staple-driving element 32 at the staple-driving position P2 is carried by the staple-driving element carrier 31 back to the ready-for-driving position P1. Meanwhile, the return spring 42 upward pushes against the movable member 41 of the wire-bending mechanism 40, so that the movable member 41 is moved to a top of the second wire-bending gas flowing space 142 of the wire-bending control chamber 14 and brings the wire-bending element 44 via the transmission assembly 43 to move from the wire-bending position P4 back to the ready-for-bending position P3.

As shown in FIG. 10E, in the process the wire-bending element 44 is moving from the wire-bending position P4 back to the ready-for-bending position P3, the transmission assembly 43 also brings the swing arm 52 to swing clockwise about the pivot end 521, the boss 433 is also moving in along the movement rail 522 away from the pivot end 521 of the swing arm 52. With the limiting unit 53 provided between the swing arm 52 and the first pulley 511, the first pulley 511 can rotate when the swing arm 52 swings clockwise. Via the transmission belt 513, the rotating first pulley 511 brings the second pulley 512 to rotate at the same time. Meanwhile, the moving transmission belt 513 brings the uppermost one of the superposed staple-forming wire strips 22 to move toward the driving guide block 15, such that the already bent staple-forming wire is located between the staple-driving element 32 and the staple outlet 151a, and a following staple-forming wire 221 is located between the wire-bending element 44 and the bending block 152. Thereby, when the trigger 121 is pulled next time, the staple-driving element 32 and the wire-bending element 44 are moved to the staple-driving position P2 and the wire-bending position P4, respectively, to complete the staple-driving and the wire-bending operation.

Please refer to FIG. 10F. When the swing arm 52 swings clockwise, the bearing shaft 531b will cause the rollers 531e to press against the push springs 531f, so that a clearance is formed between each roller 531e and the wall surface of each corresponding movement-allowance space 531d. At this point, the bearing shaft 531b can bring the bearing case 531a to rotate along with it, and the first pulley 511 can rotate when the swing arm 52 swings clockwise.

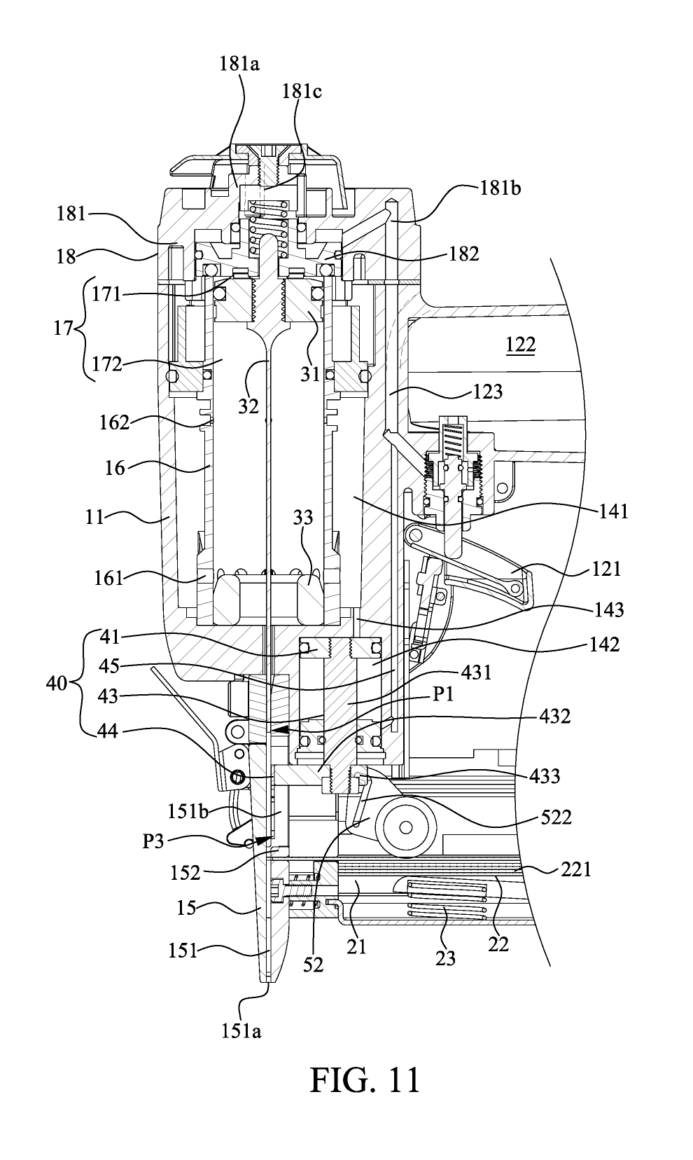

Please refer to FIG. 11, which shows a pneumatic stapler according to a second preferred embodiment of the present invention. The second preferred embodiment has a main body 10, a staple-forming wire storage mechanism 20, a staple-driving mechanism 30 and a conveying mechanism 50 structurally similar to those in the first preferred embodiment but a different wire-bending mechanism 40. Therefore, only the wire-bending mechanism 40 will be described hereinafter.

In the second preferred embodiment, the wire-bending mechanism 40 does not include any return spring 42 but has a return passage 45 formed in the staple-driving portion 11 of the main body 10 for guiding the wire-bending gas. In other words, the wire-bending mechanism 40 in the second preferred embodiment includes the movable member 41, the transmission assembly 43, the wire-bending element 44 and the return passage 45. As can be seen in FIG. 11, the return passage 45 communicates with the intake passage 123 and the second wire-bending gas flowing space 142 of the wire-bending control chamber 14, so that the intake passage 123 is communicable with the second wire-bending gas flowing space 142 via the return passage 45.

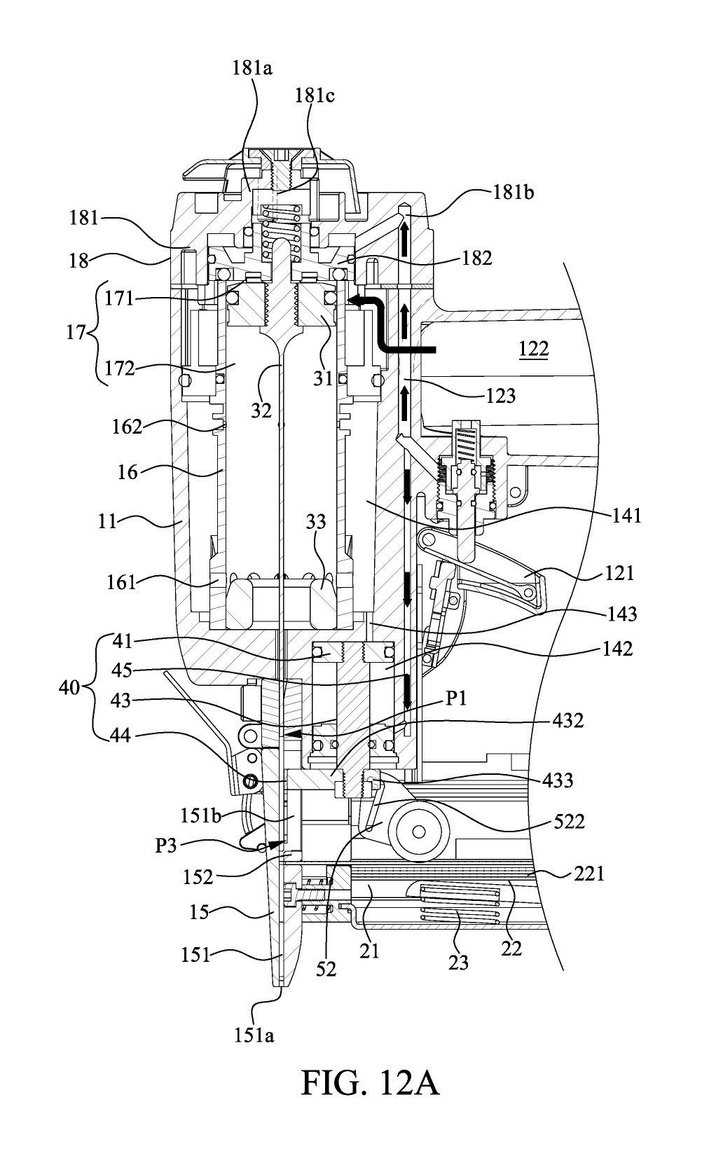

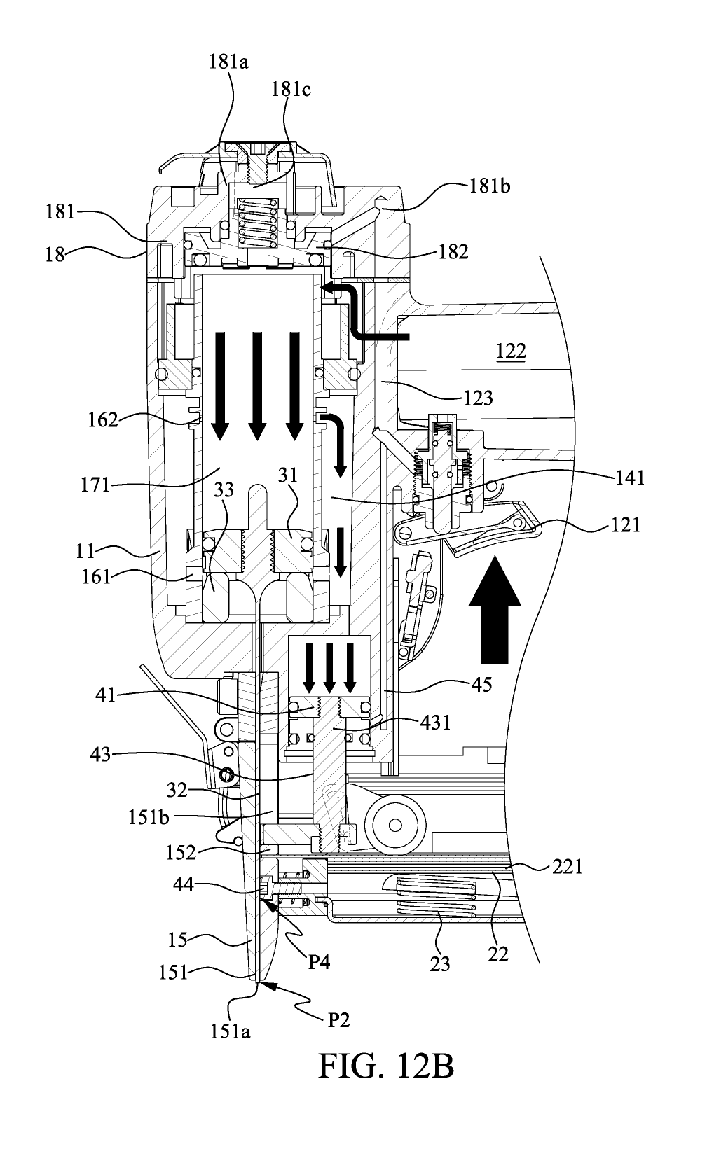

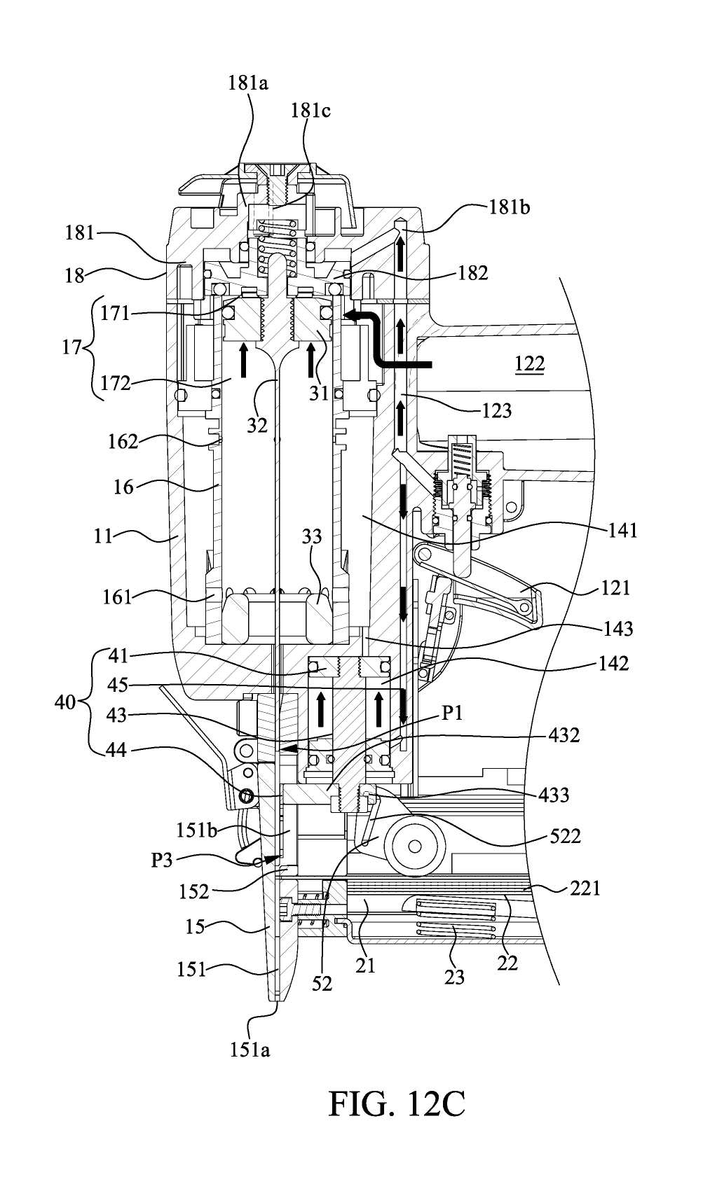

Please refer to FIG. 12A. In practical application of the pneumatic stapler according to the second preferred embodiment, when the trigger 121 is in a released state, gas is supplied from the pressure source to the intake chamber 122, the intake passage 123 and the return passage 45 at the same time. The supplied gas flowing into the intake passage 123 will push the shielding member 182 away from the fixing member 181 to shield the upper end of the cylindrical staple-driving control wall 16, so that no gap is formed between the shielding member 182 and the cylindrical staple-driving control wall 16 and no gas can flow into the staple-driving control chamber 17. Meanwhile, the supplied gas flowing into the return passage 45 finally flows into the second wire-bending gas flowing space 142 in the wire-bending control chamber 14 to upward push against the movable member 41, so that the movable member 41 is located at a highest position in the second wire-bending gas flowing space 142 and the wire-bending element 44 is located at the ready-for-bending position P3.

Please refer to FIG. 12B. When the trigger 121 is pulled, the supplied gas can flow only into the intake chamber 122 but not the intake passage 123 and the return passage 45. Thereafter, the supplied gas is divided into two parts, one of which is staple-driving gas for pushing against the staple-driving element carrier 31, and the other part is wire-bending gas for pushing against the movable member 41. With these arrangements, the staple-driving element carrier 31 can carry the staple-driving element 32 to the staple-driving position P2, and the movable member 41 can move the wire-bending element 44 via the transmission assembly 43 to the wire-bending position P4.

Please refer to FIG. 12C. When the staple-driving element 32 and the wire-bending element 44 are moved to the staple-driving position P2 and the wire-bending position P4, respectively, to complete the staple-driving operation and the wire-bending operation, and the trigger 121 of the handle portion 12 is released, the supplied gas can also flow into the intake passage 123. The supplied gas in the intake passage 123 can flow into the second wire-bending gas flowing space 142 via the return passage 45 to upward push against the movable member 41, so that the movable member 41 brings the wire-bending element 44 away from the wire-bending position P4. On the other hand, at this point, the supplied gas could not flow into the staple-driving control chamber 17 and the openings 181c are not shielded by the shielding column 182a. As a result, the staple-driving gas in the staple-driving control chamber 17 and the wire-bending gas in the wire-bending control chamber 14 can only flow through the openings 181c on the fixing member 181 into the environment outside the main body 10.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A pneumatic stapler capable of receiving an amount of gas supplied from a pressure source, comprising:
a main body having a plurality of straight staple-forming wires stored therein and internally including a staple-driving control chamber and a wire-bending control chamber;
a staple-driving mechanism including a staple-driving element carrier axially movable in the staple-driving control chamber and dividing the latter into a first and a second staple-driving gas flowing space; the first staple-driving gas flowing space initially being not communicable with the wire-bending control chamber and accordingly in an isolated state for receiving the supplied gas; and the staple-driving element carrier being able to move a staple-driving element to a staple-driving position, at where the staple-driving element pushes one of the staple-forming wires, which has already been bent into a staple, out of the main body into a workpiece; and
a wire-bending mechanism including a movable member that is axially movable in the wire-bending control chamber; and
the staple-driving element carrier being movable by the supplied gas in the staple-driving control chamber to change a size of the first staple-driving gas flowing space relative to the second staple-driving gas flowing space, such that the first staple-driving gas flowing space is no longer in the isolated state but can communicate with the wire-bending control chamber, allowing the supplied gas received in the first staple-driving gas flowing space to flow into the wire-bending control chamber to move the movable member; and the movable member moved by the supplied gas further bringing a wire-bending element to a wire-bending position for bending one of the staple-forming wires into a staple.

2. The pneumatic stapler as claimed in claim 1, wherein the second staple-driving gas flowing space is always communicable with the wire-bending control chamber, so that both of the first and the second staple-driving gas flowing space are communicable with the wire-bending control chamber in the process the wire-bending element is moving to the wire-bending position.

3. The pneumatic stapler as claimed in claim 1, wherein the wire-bending control chamber includes a first wire-bending gas flowing space located around an outer side of the staple-driving control chamber and a second wire-bending gas flowing space dimensionally smaller than the staple-driving control chamber; the first wire-bending gas flowing space being communicable with the staple-driving control chamber; and the second wire-bending gas flowing space having the movable member received therein and being communicable with the first wire-bending gas flowing space via a third wire-bending gas flowing space.

4. The pneumatic stapler as claimed in claim 3, wherein at least one first through hole and at least one second through hole diametrically smaller than the first through hole are provided between the first wire-bending gas flowing space and the staple-driving control chamber; the first through hole being axially located at a distance below the second through hole, such that a spacing distance is formed between the first and the second through hole; and the spacing distance being larger than a thickness of the staple-driving element carrier.

5. The pneumatic stapler as claimed in claim 4, wherein the second through hole is provided on the staple-driving control chamber within a middle section thereof, such that the wire-bending element is also moved to the wire-bending position when the staple-driving element is moved to the staple-driving position.

6. The pneumatic stapler as claimed in claim 4, wherein the second through hole is provided on the staple-driving control chamber within a lower part or an upper part thereof, such that the staple-driving element and the wire-bending element are sequentially moved to the staple-driving position and the wire-bending position, respectively.

7. The pneumatic stapler as claimed in claim 1, wherein the wire-bending mechanism further includes a return spring disposed in the wire-bending control chamber to normally push the movable member upward, so that the movable member brings the wire-bending element to a ready-for-bending position, which is located away from the wire-bending position, and the wire-bending element in the ready-for-bending position is located away from the staple-forming wires.

8. The pneumatic stapler as claimed in claim 1, wherein the wire-bending mechanism further includes a return passage formed in the main body; the return passage being communicable with the wire-bending control chamber for guiding the supplied gas into the wire-bending control chamber; the supplied gas flowed into the wire-bending control chamber upward pushing against the movable member, so that the movable member brings the wire-bending element to a position away from the wire-bending position.

9. The pneumatic stapler as claimed in claim 1, wherein the wire-bending mechanism further includes a transmission assembly connected to between the movable member and the wire-bending element; and the transmission assembly also being connected to a conveying mechanism installed in the main body, such that the conveying mechanism moves the staple-forming wires forward to position the first one of the staple-forming wires to one side of the staple-driving element when the wire-bending element is moved away from the wire-bending position by the movable member via the transmission assembly.

10. The pneumatic stapler as claimed in claim 9, wherein the transmission assembly includes a first transmission element axially connected to the movable member and a second transmission element horizontally connected to the first transmission element, such that the first transmission element is located parallelly to the staple-driving element while the second transmission element is located perpendicularly to the staple-driving element; and the second transmission element being connected at an end opposite to the first transmission element to the wire-bending element, so that the wire-bending element is located close to the staple-driving element.

11. The pneumatic stapler as claimed in claim 9, wherein the conveying mechanism includes a conveying assembly in contact with the staple-forming wires and a swing arm connected to between the conveying assembly and the transmission assembly; and the swing arm bringing the conveying assembly to move forward only one staple-forming wire each time and in only one direction.

12. The pneumatic stapler as claimed in claim 11, wherein a part of the swing arm forms a pivot end connected to the conveying assembly while the other part of the swing arm forms a movement rail; and the transmission assembly including an outward extended boss for extending into the movement rail, such that the swing arm swings about the pivot end when the boss moves reciprocatingly in along the movement rail.

13. The pneumatic stapler as claimed in claim 11, wherein the conveying assembly includes a transmission belt in contact with the staple-forming wires and two spaced pulleys assembled to the transmission belt; and one of the two pulleys being connected to the swing arm via a limiting unit, such that the two pulleys are limited by the limiting unit to rotate in only one direction.
